(19) United States
(12) Patent Application Publication
(10) Pub. No.: US 2009/0030600 A1
(43) Pub. Date: Jan. 29, 2009

(54) Method of providing navigation information by recalculating navigation route

(75) Inventor: Neng Liu, Hsinchu City (TW)

Correspondence Address: BACON & THOMAS, PLLC, 625 SLATERS LANE, FOURTH FLOOR, ALEXANDRIA, VA, 22314-1176, US

(73) Assignee: Mitac International Corp., Taoyuan (TW)

(21) Appl. No.: 12/153,294

(22) Filed: May 16, 2008

(30) Foreign Application Priority Data
Jul. 24, 2007 (TW) 096126884

(51) Int. Cl. G01C 21/00

(52) U.S. Cl. 701/201; 701/200; 701/207; 701/209

(57) ABSTRACT

A method of providing navigation information by recalculating a navigation route is used in a global positioning device. The method reads an original navigation route first. If another new navigation route can be read again, it shows that the global positioning device is deviated from the original navigation route, and route data of the original navigation route and the new navigation route are compared to generate a comparing information such as an overlapped position of the two navigation routes, and the time or distance required to return to the original new navigation route from the new navigation route and display the comparing information on the global positioning device to remind the users. The present invention can greatly reduce the tension of a user who is not familiar with the routes and road conditions.

### FIELD OF THE INVENTION

The present invention relates to a method of providing navigation information for a global positioning device, and more particularly to a method capable of producing a new navigation route when the global positioning device is deviated from an original navigation route, generating a comparing information through comparing route data of the original navigation route and the new navigation route, and displaying the comparing information on the global positioning device to remind user the route, time or distance needed for going back to the original navigation route.

### BACKGROUND OF THE INVENTION

As technologies advance and transportations become convenient, the range of our activities is extended to places all over the world. In such a wide range of space and a complicated traffic network, there is a need of locating a person or an object precisely, and thus global positioning system (GPS) is introduced. The GPS provides the coordinates or position of a person or an object quickly and accurately based on a signal transmitted from an artificial satellite, and various activities (such as positioning, investigation, tracking and research activities) or other operations can be controlled within a wide range according to the coordinates, and users can have a good control of the moving path of the people or object, so as to eliminate all kinds of problems caused by the unknown position and reduce the waste of efforts, time and resources.

In recent years, portable electronic communication products have become a mainstream development of electronic products, and manufacturers keep improving their products and tend to develop their products with a short, small, light and thin design, and add different functions to the products by software and hardware to meet the increasingly higher requirements of the users, and attempt to lead others in the market. Therefore, manufacturers spare no effort on enhancing or adding related global positioning system (GPS) functions in various portable electronic communication products and digital products such as mobile phones, personal digital assistants (PDA) and global positioning devices, such that the electronic products can achieve the effect of controlling the moving path of the people and object anytime and anywhere.

In general, the present GPS installs a navigation software in a global positioning device, and the navigation software can provide at least one map information (such as the map of Taiwan) and displays the map information on a display screen of the global positioning device. After the global positioning device receives a satellite signal to compute a mathematical value (such as longitude, latitude, minute and second, etc) of the current position of the global positioning device, the navigation software will substitute the mathematical value into the map information to obtain the current position of a person or an object and its corresponding map from the map information, and display the information on the display screen, so that users can know the current position from the map through the display screen. With the function of the planned route provided by the navigation software, users can follow the direction and instruction of the planned route to reduce the chance of getting lost.

Although users can drive according to the planned route provided by the navigation software, users usually find it difficult to follow the planned route precisely. If a two-way road is changed to one-way, a road is damaged, under construction, or blocked, or a driver misses an intersection of complicated roads, the navigation software can provide a new planned route automatically, yet the driver may not be familiar with the roads or road conditions, and thus inexperienced users may get panic and become nervous. Therefore, users can relieve their anxiety, if related information on how to get back to the original planned route is provided, after a new route is planned.

### SUMMARY OF THE INVENTION

In view of the shortcomings of the prior art that users cannot drive a car exactly according to a planned route provided by a navigation software, the inventor of the present invention based on years of experience in the related industry to conduct extensive researches and experiments, and finally developed a method of providing navigation information by recalculating a navigation route in accordance with the present invention to overcome the shortcomings of the prior art.

It is a primary objective of the present invention to provide a method of providing navigation information by recalculating a navigation route, and the method is used in a global positioning device. The method reads an original navigation route first. If another new navigation route can be read again, it shows that the global positioning device is deviated from the original navigation route, and route data of the original navigation route and the new navigation route are compared to generate a comparing information (such as an overlapped position of the two navigation routes, and the time or distance required to return to the original new navigation route from the new navigation route) and display the comparing information on the global positioning device to remind the users. The present invention can greatly reduce the pressure of users who are not familiar with the routes and road conditions.

### BRIEF DESCRIPTION OF THE DRAWINGS

FIG. 1 is a flow chart of the present invention;

FIG. 2 is a schematic view of providing navigation information on a global positioning device in accordance with the present invention; and

FIG. 3 is another flow chart of the present invention.

### DETAILED DESCRIPTION OF THE PREFERRED EMBODIMENTS

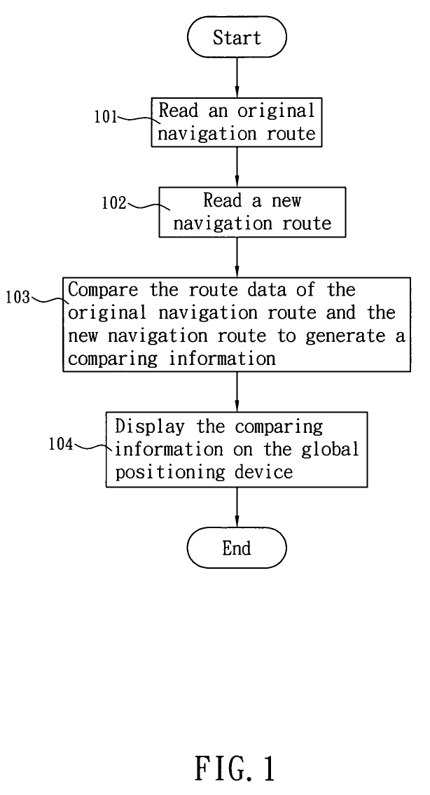

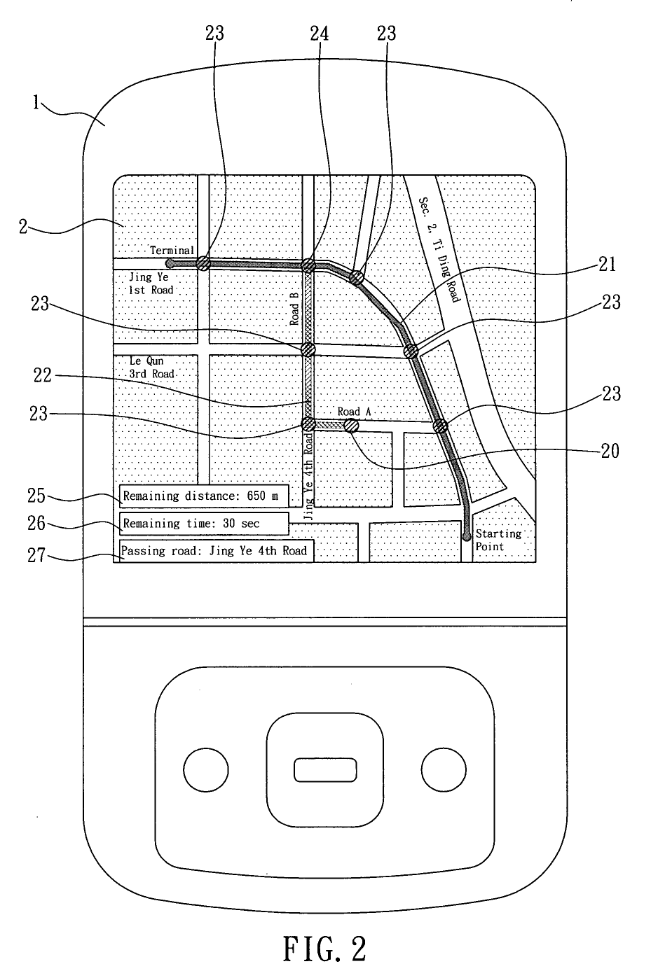

Referring to FIGS. 1 and 2 for a method of providing navigation information by recalculating a navigation route in accordance with the present invention, the method is applied in a global positioning device 1, and the method comprises the following steps:

Step (101): Read an original navigation route 21.

Before reading the original navigation route 21, the method of the invention uses a path computation mechanism to compute the original navigation route 21, and the global positioning device 1 receives a target positioning value inputted by a user of the global positioning device 1 as a desired destination. Then, the global positioning device 1 receives a satellite signal to compute a current positioning value according to the satellite signal. The current positioning value includes a longitude and a latitude, and the current positioning value can be analyzed. In a map information stored in the global positioning device 1, a label 20 is marked on a map displayed on the global positioning device 1 as shown in FIG. 2. Finally, the global positioning device 1 computes the original navigation route 21 according to the target positioning value, the current positioning value and the map information and provides such information to users for reference.

Step (102): Read a new navigation route 22.

In FIG. 2, if the global positioning device 1 is deviated from the original navigation route 21 (such as a road is damaged, under construction or blocked, a two-way road is changed to one-way, or a user misses an intersection) after the method reads the original navigation route 21, the new navigation route 22 is produced and read, and the new navigation route 22 is a current positioning value of the global positioning device 1 read by the global positioning device 1 once every setup time. If the current positioning value is determined to be not in the range of the original navigation route 21, it shows that the global positioning device 1 is deviated from the original navigation route 21, and the target positioning value, the current positioning value and the map information can be used for computing the new navigation route 22 for the users' reference.

Step (103): Compare the route data of the original navigation route 21 and the new navigation route 22 to generate a comparing information.

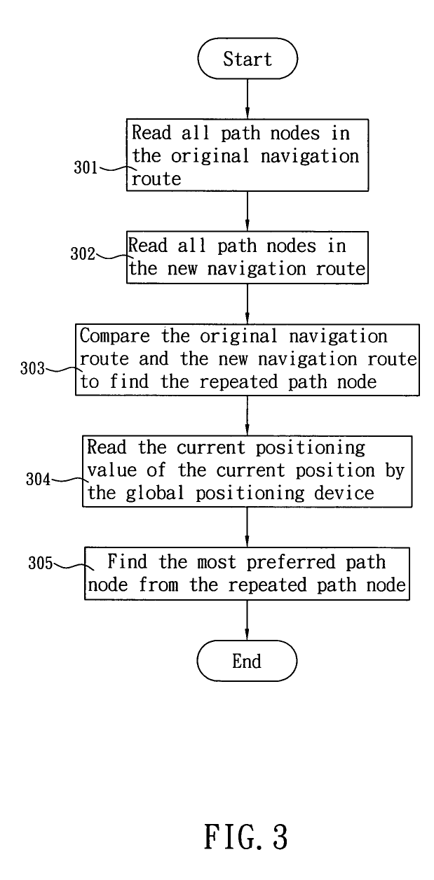

In FIG. 3, the method of the invention compares route data of the original navigation route 21 and the new navigation route 22 to generate the comparing data, and the method further comprises the following steps:

Step (301): Read all path nodes 23 in the original navigation route 21;

In FIG. 2, the map information stores a plurality of path nodes 23, and the path nodes 23 are intersections of the roads in the map information. In the invention, the global positioning device 1 can search the path nodes 23 passing through the original navigation route 21, after the original navigation route is computed.

Step (302): Read all path nodes 23 in the new navigation route 22;

In the invention, the global positioning device 1 can search the path nodes 23 passing through the new navigation route 22 at the same time, after the new navigation route is computed.

Step (303): Compare the original navigation route 21 and the new navigation route 22 to find the repeated path node 23.

In the invention, if the global positioning device 1 compares the original navigation route 21 and the new navigation route 22 and finds the repeated path node 23, it shows that there is an overlapped road section of the original navigation route 21 and the new navigation route 22 at the overlapped position of the original navigation route 21 and the new navigation route 22. In Step (301) to Step (303), the operation of comparing the route data of the original navigation route 21 and the new navigation route 22 can be achieved.

Step (304): Read the current positioning value of the current position by the global positioning device 1.

Step (305): Find the most preferred path node 24 closest to the current positioning value from the repeated path node 23 of the original navigation route 21 and the new navigation route 22, and the most preferred path node 24 is an overlapped position of the original navigation route 21 and the new navigation route 22. After a user is deviated from the original navigation route 21, the closest intersection for returning to the original navigation route 21 can be found on the new navigation route 22.

Step (104): Display the comparing information on the global positioning device 1.

Referring to FIG. 2 for a preferred embodiment of the present invention, when the comparing information is displayed in accordance with a method of the present invention, a node positioning value of the most preferred path node 24 is read first, and the most preferred path node 24 is marked on the map information according to the node positioning value, so that users can find the closest intersection for returning to the original navigation route 21 on a map 2 displayed on the global positioning device 1. After the most preferred path node 24 is marked on the map information, the method reads a current positioning value of the global positioning device 1 once every setup time, and computes a remaining distance 25 (such as 500 meters) according to the current positioning value and the node positioning value, and displays the remaining distance 25 on the global positioning device 1, so that users can know how to return to the original navigation route. After the remaining distance 25 is displayed on the global positioning device 1, the current speed of the global positioning device 1 and the remaining distance 25 can be read, and a remaining time 26 (such as 60 seconds) can be computed according to the speed and remaining distance 25, and the remaining time 26 is displayed on the global positioning device 1, so that users can know how much time its takes to return to the original navigation route 21.

Referring to FIG. 2 again, when a comparing information is read in a method of another preferred embodiment of the present invention, a non-repeated path node 23 of the new navigation route 22 and the original navigation route 21 is read first, and then the non-repeated path node 23 is marked on the map information according to the node positioning value of the non-repeated path node 23, and the non-repeated path node 23 is an intersection for returning to the original navigation route 21. Then, a passing road 27 corresponding to the non-repeated path node 23 in the map information is read, and the passing road 27 is a road with a name (such as Section 1 of Ching Tek Road) that leads the users back to the original navigation route 21, and the passing road 27 is displayed on the global positioning device 1, and thus the invention can provide users more related road condition data for reference.

In summation of the description above, the method of providing navigation information by recalculating a navigation route in accordance with the present invention can achieve the following effects and purposes:

1. After a user is deviated from the original navigation route 21, the closest intersection for returning to the original navigation route 21 from the new navigation route 22 can be displayed, so that the user can return to his/her familiar original navigation route 21 quickly.

2. The invention provides users the information such as the remaining time 26 and the remaining distance 25 for the users to return to the original navigation route 21, and thus releases the users' tension of missing the original navigation route 21.

3. After the passing road 27 is displayed on the global positioning device 1, users can know the names of the passing roads that will take the users back to the original navigation route 21 and reduce the unfamiliarity of the road conditions and routes. During the process of returning to the original navigation route 21, users can ease away their anxiety.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A method of providing navigation information by recalculating a navigation route, applied in a global positioning device, and comprising the steps of:
reading an original navigation route;
reading a new navigation route;
comparing route data of the original navigation route and the new navigation route to generate a comparing information; and
displaying the comparing information on the global positioning device.

2. The method of providing navigation information by recalculating a navigation route as recited in claim 1, wherein when the route data of the original navigation route and the new navigation route are compared, the method further comprising the steps of:
reading all path nodes in the original navigation route;
reading all path nodes in the new navigation route; and
comparing the original navigation route and the new navigation route to find a repeated path node.

3. The method of providing navigation information by recalculating a navigation route as recited in claim 2, wherein the method produces the comparing information by a procedure comprising the steps of:
reading a current positioning value of the current position of the global positioning device; and
finding the most preferred path node closest to the current positioning value from the repeated path nodes of the original navigation route and the new navigation route.

4. The method of providing navigation information by recalculating a navigation route as recited in claim 3, wherein after displaying the comparing information, the method further comprises the steps of:
reading a node positioning value of the most preferred path node; and
marking the most preferred path node on a map information according to the node positioning value.

5. The method of providing navigation information by recalculating a navigation route as recited in claim 4, wherein after marking the most preferred on the map information, the method further comprises the steps of:
reading a current positioning value of the global positioning device once every setup time;
computing a remaining distance according to the current positioning value and the node positioning value; and
displaying the remaining distance on the global positioning device.

6. The method of providing navigation information by recalculating a navigation route as recited in claim 5, wherein after displaying the remaining distance on the global positioning device, the method further comprises the steps of:
reading a current speed of the global positioning device;
reading the remaining distance;
computing a remaining time according to the speed and the remaining distance; and
displaying the remaining time on the global positioning device.

7. The method of providing navigation information by recalculating a navigation route as recited in claim 3, wherein while displaying the comparing information, the method further comprises the steps of:
reading a non-repeated path node of the new navigation route and the original navigation route; and
marking the non-repeated path node on a map information according to the node positioning value of the non-repeated path node.

8. The method of providing navigation information by recalculating a navigation route as recited in claim 7, wherein after marking the non-repeated path node in the map information, the method further comprises the steps of:
reading a passing road corresponding to a non-repeated path node from the map information according to the non-repeated path node; and
displaying the passing road on the global positioning device.

9. The method of providing navigation information by recalculating a navigation route as recited in claim 6, wherein before reading the original navigation route, the method further comprises the steps of:
receiving a target positioning value;
receiving a satellite signal to compute the current positioning value according to the satellite signal; and
computing the original navigation route according to the target positioning value, the current positioning value and the map information.

10. The method of providing navigation information by recalculating a navigation route as recited in claim 8, wherein before reading the original navigation route, the method further comprises the steps of:
receiving a target positioning value;
receiving a satellite signal to compute the current positioning value according to the satellite signal; and
computing the original navigation route according to the target positioning value, the current positioning value and the map information.

11. The method of providing navigation information by recalculating a navigation route as recited in claim 9, wherein after reading the original navigation route and after reading the new navigation route, the method further comprises the steps of:
reading the current positioning value of the global positioning device once every setup time; and
computing the new navigation route according to the target positioning value, the current positioning value and the map information, if the current positioning value is not within the range of the original navigation route.

12. The method of providing navigation information by recalculating a navigation route as recited in claim 10, wherein after reading the original navigation route and after reading the new navigation route, the method further comprises the steps of:
reading the current positioning value of the global positioning device once every setup time; and
computing the new navigation route according to the target positioning value, the current positioning value and the map information, if the current positioning value is not within the range of the original navigation route.
